(19) United States
(12) Patent Application Publication
(10) Pub. No.: US 2026/0299246 A1
(43) Pub. Date: Oct. 1, 2026

(54) AIR-BLOWING OPTICAL CABLE

(71) Applicant: Jiangsu Zhongtian Technology Co., Ltd., Jiangsu (CN)

(72) Inventors: Pengyu ZHU, Jiangsu (CN); Xiaoming MIAO, Jiangsu (CN); Weiwei MIAO, Jiangsu (CN); Yingying MIAO, Jiangsu (CN); Xu YOU, Jiangsu (CN); Jingtao LIN, Jiangsu (CN); Yanhao CHEN, Jiangsu (CN)

(73) Assignee: Jiangsu Zhongtian Technology Co., Ltd., Jiangsu (CN)

(21) Appl. No.: 19/691,477

(22) Filed: May 28, 2026

Related U.S. Application Data
(63) Continuation of application No. PCT/CN2025/128796, filed on Oct. 20, 2025.

(30) Foreign Application Priority Data
Mar. 25, 2025 (CN) 202510356529.5

(51) Int. Cl. G02B 6/52; G02B 6/44

(52) U.S. Cl. CPC G02B 6/52; G02B 6/4432

(57) ABSTRACT

An air-blowing optical cable, includes a cable core and an outer sheath coated on the outside of the cable core. A protruding strip is provided on an outer wall of the outer sheath, and a height direction of the protruding strip extends outward along a radial direction of the optical cable, and the protruding strip has a length direction extending along an axial direction of the air-blowing optical cable and spirally surrounds an outer surface of the outer sheath. Gas advances along a spiral direction of the protruding strip, generating a thrust component on the optical cable along the axial direction; and a propelling force F_{f} that is generated by the thrust component to propel each meter of optical cable to move is greater than 50N. The protruding strip is provided on the outer side of the outer sheath, reducing friction during the laying of optical cable and external conduits.

### CROSS-REFERENCE TO RELATED APPLICATIONS

The present application is a continuation of International PCT Application No. PCT/CN2025/128796, filed on Oct. 20, 2025, which claims priority to the Chinese Patent Application No. 202510356529.5, filed with the China National Intellectual Property Administration on Mar. 25, 2025, and entitled “Air-blowing Optical Cable”. The aforementioned patent applications are hereby incorporated by reference in its entireties.

### TECHNICAL FIELD

The present application relates to optical cable products, particularly to an air-blowing optical cable.

### BACKGROUND

An air-blowing optical cable is a technology that uses compressed gas (typically air) to propel optical cables or electric cables through interior of the conduits. This technology is mainly employed for optical fiber or electric cable laying, especially in locations where manual laying is difficult, such as long-distance underground conduits. The air-blowing optical cable offers advantages such as high-efficiency cable laying, reduced damage, long-distance laying capability, decreased labor intensity, and strong scalability, and thus is widely used in telecommunications industry and other fields requiring long-distance electric cable laying, particularly in a construction of optical fiber network.

However, current air-blowing optical cables exhibit low-efficiency cable laying, and cannot complete the laying of optical cables quickly and efficiently. Therefore, there is a need for an optical cable that can achieve rapid and high-efficiency completion of laying.

### SUMMARY

The present application overcomes the shortcomings of the prior art and provides an air-blowing optical cable.

To achieve the above objective, the technical solution adopted in the present application is as follows. An air-blowing optical cable includes a cable core and an outer sheath coated on an outer side of the cable core, where a protruding strip is provided on an outer wall of the outer sheath, the protruding strip has a height direction extending outward along a radial direction of the optical cable, the protruding strip has a length direction extending along an axial direction of the air-blowing optical cable and spirally surrounds an outer surface of the outer sheath, and gas advances along a spiral direction of the protruding strip, generating a thrust component on the optical cable in the axial direction of the air-blowing optical cable; and a propelling force F_{f} that is generated by the thrust component to propel each meter of optical cable to move, is greater than 50N, and a calculation formula for the propelling force F_{f} is:

$${F}_{f} = S \cdot μ ( θ ) \cdot {P}_{P} \cdot h ;$$

where:

$$S = \sqrt{\frac{{( 2 π r )}^{2}}{{p}^{2}} + 1} \cdot L ; \\ μ ( θ ) = μ \cdot sin θ ; \\ θ = acr tan ( \frac{p}{2 π r} ) ;$$

F_{f} is a propelling force exerted on the optical cable during an air-blowing process;
S is a total length of the protruding strip when a starting point of the protruding strip is unfolded along a circumference direction of the optical cable;
μ(θ) is a composite friction coefficient;
r is a radius of the optical cable sheath;
p is a pitch;
L is a total length of the optical cable;
θ is an acute angle between a spiral protruding strip and the axial direction of the optical cable;
P_{P} is an internal pressure within the conduit under a given air-blowing device and conduit; and
h is a height of the protruding strip.

More specifically, the pitch of the spiral protruding strip is set to be less than or equal to 0.5 m.

More specifically, the pitch of the spiral protruding strip is set to be 0.01-0.5 m.

More specifically, the protruding strip is set to be an arc or a trapezoid on any radial plane of the air-blowing optical cable; when the cross-section of the protruding strip is provided to be a trapezoid, cross-sectional dimensions of the protruding strip increase as it approaches the outer sheath.

More specifically, reinforcing members are provided within the outer sheath, and the reinforcing members are provided within the outer sheath circumferentially and uniformly.

More specifically, the reinforcing member is provided as an aramid fiber rod or a glass fiber rod.

More specifically, the outer sheath is formed of polyethylene material.

More specifically, the cable core includes a plurality of optical fibers and bonding parts that bond the plurality of optical fibers intermittently in an axial direction, two colored threads are provided outside the plurality of optical fibers, and the two colored threads are wound in opposite directions to bind the plurality of optical fibers into a bundle.

More specifically, any bonding part on any optical fiber is a first reference bonding part; an adjacent bonding part on the optical fiber adjacent to the first reference bonding part is a second reference bonding part; an adjacent bonding part on the optical fiber adjacent to the second reference bonding part is a third reference bonding part; where the first reference bonding part, the second reference bonding part, and the third reference bonding part are located on a same straight line.

More specifically, the air-blowing optical cable has a rigidity of 0.45-1.85 N·m².

The present application addresses the shortcomings present in the background art and offers the following beneficial effects: protruding strips are provided on the outer side of the outer sheath, reducing friction during the laying of optical cable and external conduits and ensuring the completion of air-blowing optical cable laying; meanwhile, controlling the propelling force F_{f} exerted by the gas to propel each meter of optical cable to be greater than 50N, enables the laying of the optical cable to be completed more quickly and smoothly, saving time and effort.

### BRIEF DESCRIPTION OF DRAWINGS

The following provides a further explanation of the present application in combination with the accompanying drawings and the embodiments.

FIG. 1 is a radial cross-sectional view of an optical cable of the present application with a protruding strip configured as an arc.

FIG. 2 is a radial cross-sectional view of an optical cable of the present application with a protruding strip configured as a trapezoid.

FIG. 3 is a schematic structural diagram of a plurality of optical fibers in the present application forming an optical fiber ribbon in cooperation with bonding parts.

FIG. 4 is a schematic structural diagram of an optical fiber bundle formed by binding an optical fiber ribbon and one water-blocking yarn with a colored thread in the present application.

FIG. 5 is a schematic diagram showing a specific correspondence of various physical variables on a surface of an optical cable in the present application.

In the figures:

1—cable core; 11—optical fiber; 12—bonding part; 13—water-blocking yarn; 14—colored thread; 15—optical fiber ribbon; 16—optical fiber bundle; 2—water-blocking ribbon; 3—outer sheath; 4—reinforcing member; 5—protruding strip.

### DESCRIPTION OF EMBODIMENTS

In order to make the objectives, technical solutions, and advantages of the present application clearer, the technical solutions of the embodiments of the present application will be further detailed in combination with the accompanying drawings in the embodiments of the present application. Throughout the accompanying drawings, identical or similar reference numerals denote identical or similar elements or elements performing identical or similar functions. The described embodiments represent a part of embodiments of the present application, not all embodiments. The embodiments described below in combination with the accompanying drawings are exemplary and intended to explain the present application, but should not be construed as limiting the present application. All other embodiments obtained by those skilled in the art based on the embodiments of the present application without creative labor fall within the scope of protection of the present application.

In the description of the present application, it should be understood that the terms such as “center”, “longitudinal”, “transverse”, “front”, “back”, “left”, “right”, “vertical”, “horizontal”, “top”, “bottom”, “inside”, and “outside” indicate orientations or positional relationships based on the orientations or positional relationships shown in the accompanying drawings. These are used only for the purpose of facilitating the description of the present application and simplifying the description, and are not intended to indicate or imply that the devices or elements referred to must have a specific orientation, or be constructed and operated in a specific orientation. Therefore, they should not be construed as limiting the scope of protection of the present application. The embodiments of the present application will now be described in detail in combination with the accompanying drawings.

It should be understood that the accompanying drawings are only used for illustrative explanation of the present application.

The present application is now described in further detail in combination with the drawings and embodiments. These drawings are simplified schematic diagrams intended to illustrate a basic structure of the present application in a schematic manner and therefore show only the components relevant to the present application.

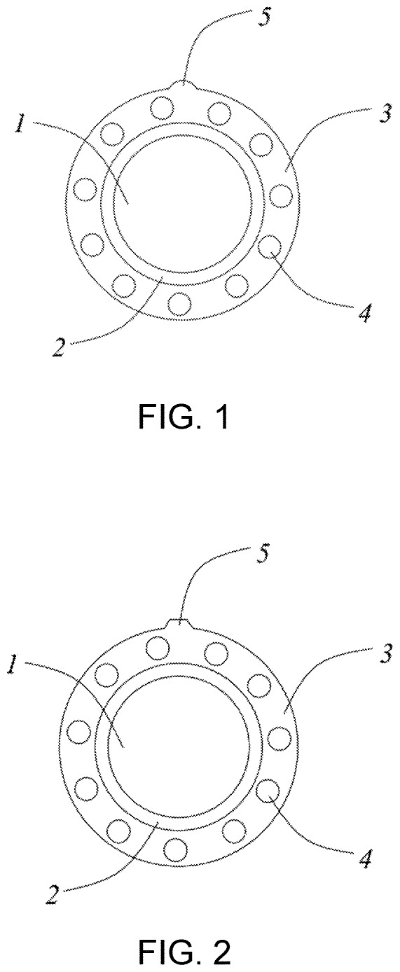

An air-blowing optical cable, as shown in FIGS. 1-5, includes a cable core 1 and an outer sheath 3 covering the cable core 1.

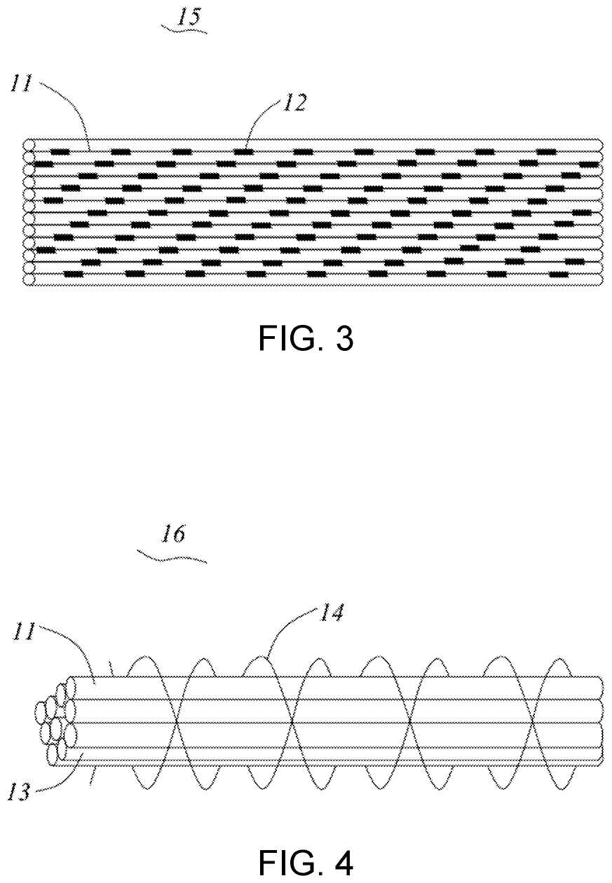

As shown in FIG. 3, the cable core 1 includes a plurality of optical fibers 11 and bonding parts 12 that intermittently bond the plurality of optical fibers 11 in an axial direction of optical fibers, any bonding part 12 on any optical fiber 11 is a first reference bonding part; an adjacent bonding part 12 on the optical fiber 11 adjacent to the first reference bonding part is a second reference bonding part; an adjacent bonding part 12 on the optical fiber 11 adjacent to the second reference bonding part is a first reference bonding part or a third reference bonding part, for example, the adjacent bonding part 12 on the optical fiber 11 adjacent to one side of the second reference bonding part is the first reference bonding part, and the adjacent bonding part 12 on the optical fiber 11 adjacent to the other side of the second reference bonding part is the third reference bonding part; where the first reference bonding part, the second reference bonding part, and the third reference bonding part are located on a same straight line. For example, three optical fibers 11 are arranged, and respectively designated as a first optical fiber, a second optical fiber, and a third optical fiber in order. Each optical fiber 11 is provided with three bonding parts 12, which are respectively designated as a first bonding part, a second bonding part, and a third bonding part sequentially. The first bonding part on the second optical fiber is defined as the first reference bonding part; the optical fibers adjacent to the first reference bonding part are the first optical fiber and the third optical fiber respectively; the bonding parts adjacent to the first reference bonding part are a first bonding part of the first optical fiber and a first bonding part of the third optical fiber and the two first bonding parts serve as the second reference bonding part. If there is also a fourth optical fiber, an optical fiber adjacent to the second reference bonding part is the fourth optical fiber; the second reference bonding part is adjacent to a first bonding part of the fourth optical fiber, which serves as the third reference bonding part. The first reference bonding part, the second reference bonding part, and the third reference bonding part are located on a same straight line, namely, the first bonding part of the first optical fiber, the first bonding part of the second optical fiber, the first bonding part of the third optical fiber, and the first bonding part of the fourth optical fiber are located on a same straight line.

The optical fiber ribbon 15 employs a high-precision dispensing technology, so that the connecting lines between adjacent bonding parts 12 of any adjacent optical fibers 11 are all located on a same straight line. In the present solution, the bonding parts 12 are configured as adhesive dots with a mutual deviation of less than 0.1 mm. This high precision is beneficial for ensuring that, during an overall fusion-welding process of the optical fiber ribbon 15, the gap between cross-sections of several optical fibers 11 after cutting is extremely small, which maximally guarantees a stability of the fusion-welding performance and helps to reduce a fusion-welding loss.

In the present solution, a size of bare optical fiber is set to be 230 μm-240 μm; the optical fiber 11 is colored and the colored optical fiber 11 has a size of 235 μm-245 μm; and then, one layer of resin is coated on the surface of the colored optical fiber 11, and the optical fiber 11 coated with the resin has a size of 240 μm-250 μm.

The optical fiber 11 has a dispensing length of D2=20±5 mm, and a dispensing distance D3=40±5 mm; an inclined size D4 of the optical fiber 11 is just as D4=D2*(the number of optical fiber 11-1), where an overall width D1 of the optical fiber bundle 16=the size of the optical fiber 11 coated with the resin*N+(40−60 μm), N refers to number of optical fibers, and the “40-60 μm” is a correction factor, i.e., the tiny gaps existing directly between the optical fibers 11, which provides the optical fibers 11 with more mobility and resistance to external forces. Compared to conventional adhesive-dot bonded optical fiber ribbon 15, it can achieve an equal strength with smaller adhesive-dots; and if adhesive-dots with the same size are used, greater strength can be obtained.

The optical fiber ribbon 15 with a dispensing structure can ensure a tight bonding between the optical fibers 11 with very little adhesive usage. Traditional optical fiber ribbon 15 uses a full resin coating, which will cause the overall structure of the optical fiber ribbon 15 to solidify; and once it is wound, the optical fiber ribbon 15 will be damaged, resulting in a fixed space occupation within the optical cable. The optical fiber ribbon 15 disclosed in the present solution may be integrally wound into a single strand with the optical fibers 11 or twisted by less than one turn, greatly enhancing its flexibility, significantly reducing the space required for the optical fiber ribbon 15 and providing a smaller bending radius.

As shown in FIG. 4, two colored threads 14 are provided outside a plurality of optical fibers 11, and are wound in opposite directions to bind the plurality of optical fibers 11 into a bundle. The plurality of optical fibers 11 are bonded with each other to form an optical fiber ribbon 15; two colored threads 14 may only bind a single optical fiber ribbon 15, or may bind multiple optical fiber ribbons. One or more optical fiber ribbons 15 combined with one water-blocking yarn are wrapped by two colored threads to form an optical fiber bundle 16. A water-blocking yarn 13 is provided within the optical fiber bundle 16. The water-blocking yarn 13 is a high-expansion type water-blocking yarn. The colored thread 14 binds one or more optical fiber ribbons 15 and one water-blocking yarn 13 to form an optical fiber bundle 16; and several optical fiber bundles 16 are then twisted together to form a cable core 1. One or more optical fiber ribbons 15 and one high-expansion type water-blocking yarn are prepared, and then two colored threads 14 are prepared and bind one or more optical fiber ribbons 15 and one water-blocking yarn 13 together by winding in opposite directions. The colored thread 14 uses 111D polyester yarn, and the polyester yarn can be designed in different colors according to requirements, making it easy to distinguish different optical fiber bundles 16. In any bundle, the optical fiber ribbons 15 can be distinguished by spray-printed markings. A binding pitch of the colored thread 14 is provided to be less than 7 cm, and making the binding pitch of the colored thread 14 a small pitch can facilitate better direct differentiation of the optical fiber bundles 16. Conventional optical fiber bundles 16 typically only have inkjet coding on the surface of the optical fiber ribbon 15; when the inkjet coding serves as a main identification method, it becomes difficult to quickly distinguish each optical fiber bundle 16 as the number of cores increases. In the technical solution of the present application, different colored yarns may enable a construction personnel to quickly separate different optical fibers based on the colored thread 14, significantly improving a fusion-welding efficiency of optical fiber bundles 16 with ultra-high number of cores.

As shown in FIGS. 1 and 2, in order to reduce a friction when the optical cable is air-blowing and laid into external conduits, a protruding strip 5 is arranged on an outer wall of the outer sheath 3. A height direction of the protruding strip 5 extends outward along a radial direction of the optical cable; and the protruding strip 5 has a length direction extending along an axial direction of the air-blowing optical cable and spirally surrounds an outer surface of the outer sheath 3. If the protruding strip 5 is not provided spirally, an effect of air-blowing laying is poor. To ensure air-blowing laying when the optical cable enters the external conduit, the protruding strip 5 spirally surrounds the outer surface of the outer sheath, with the pitch of the spiral protruding strip 5 being set to be less than or equal to 0.5 m. When the pitch is greater than 0.5 m, the effect of air-blowing laying is poor. Further, when the pitch of the spiral protruding strip 5 is set to be 0.01-0.5 m, only one protruding strip 5 is present on any radial cross-section of the optical cable, resulting in a better air-blowing effect.

The protruding strip 5 is protrudingly provided on the outer sheath 3 and disposed on the entire outer surface of the optical cable. Providing the protruding strip 5 can reduce the friction between the optical cable and the sheath during laying, thereby improving laying efficiency.

Providing the protruding strip 5 may reduce a contact area between the optical cable and the external conduit, thereby decreasing friction within the conduit and adapting to air-blowing applications. Its principle lies in the fact that if an entire surface of the outer sheath 3 contacts with the conduit, it is difficult to avoid the unevenness of the surface of the outer sheath 3 at the microscopic scale, and an increased surface roughness of the outer sheath 3 leads to higher friction, but after providing frictional protrusions, a contact mode shifts from a surface-to-surface contact to a linear contact, and the points where friction can occur are greatly reduced; meanwhile, during the air-blowing process, frictional surface of the airflow on the optical cable may also be increased, which is beneficial for the airflow to lift the optical cable within the conduit, reducing an interface pressure and decreasing a friction force.

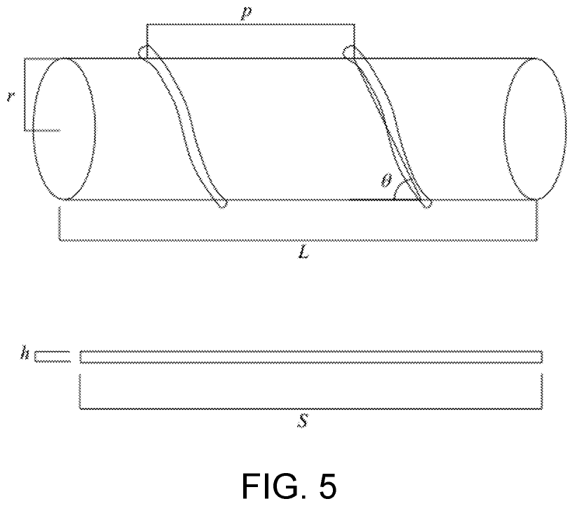

As shown in FIG. 5, during the air-blowing laying of optical cable, gas advances along a spiral direction of the protruding strip, generating a thrust component on the optical cable along the axial direction to propel the optical cable into the external conduit. Regardless of the magnitude of the propelling force, as long as there is sufficient time, the optical cable can be laid within the conduit. However, when the propelling force is small, the laying of the optical cable is rather time-consuming and labor-intensive, and the laying effect is poor. To ensure the efficiency of air blowing laying, a propelling force F_{f} that is generated by the thrust component for driving each meter of optical cable to move, is set to be greater than 50N. When the optical cable is set to be 1 meter, the propelling force F_{f} is greater than 50N; when the optical cable is set to be 5 meters, the propelling force F_{f} is greater than 250N; when the optical cable is set to be 10 meters, the driving force F_{f} is greater than 500N, and so on.

When the propelling force each meter of optical cable is greater than 50N, the laying speed of the optical cable is fast and its laying effect is good; and a calculation formula for the propelling force F_{f} is:

$${F}_{f} = S \cdot μ ( θ ) \cdot {P}_{P} \cdot h ;$$

where:

$$S = \sqrt{\frac{{( 2 π r )}^{2}}{{p}^{2}} + 1} \cdot L ; \\ μ ( θ ) = μ \cdot sin θ ; \\ θ = acr tan ( \frac{p}{2 π r} ) ;$$

F_{f} refers to a propelling force acting on a specific length of optical cable during an air-blowing process, generated by the friction between the optical cable and the gas, along a direction of the optical cable's movement, i.e., the propelling force exerted on the optical cable; its higher value is more conducive to improving the air-blowing effect of the optical cable; however, this value is limited by manufacturing processes, conduit dimensions, and other physical properties of the optical cable and cannot increase indefinitely;
S is a total length of the protruding strip 5 when a starting point of the protruding strip 5 is unfolded along a circumference of the optical cable; under air-blowing conditions, it represents the length of the protrusion within the optical cable that is available to increase contact with high-pressure air;
μ(θ) is a composite friction coefficient; under a given material of the outer sheath 3 and a given helical direction, it defines an axially propelling effect exerted by the air-driven frictional force on the optical cable. It is a function defined by the friction coefficient of the specific material of the outer sheath 3 and an acute angle θ between the spiral protruding strip 5 and the axial direction of the optical cable; μ is a kinetic friction coefficient of a given material of the outer sheath 3 under a specified working condition. When the material of the outer sheath 3 is determined, a final calculation result for μ(θ) can be transformed into a function of the pitch p;
r is a radius of the sheath of optical cable;
p is a pitch, representing a distance between the closest two spiral protruding strips 5 on any plane passing through the geometric center of the optical cable;
L is a total length of the optical cable;
θ represents an angle between a spiral protruding strip 5 and the axial direction of the optical cable;
μ is a kinetic friction coefficient of a given material of the outer sheath 3 under a specified working condition;
P_{P} is an internal pressure within conduit under a given air-blowing device and conduit, where the air-blowing process is considered as a process with constant-pressure within the conduit; and
h is a height of the protruding strip 5.

Detailed calculation steps of

$$S = \sqrt{\frac{{( 2 π r )}^{2}}{{p}^{2}} + 1} \cdot L$$

are as follows:
a length of a spiral protruding strip within one pitch is: s²=2πr²+p²,
so, s=\sqrt{2πr²+p²},
a length of a segment of an optical cable is L, and there are n pitches within the segment of optical cable; therefore, when the length of the optical cable is L,

$$n = \frac{L}{p} ,$$

so, in the segment of the optical cable with the length of L, the total length of the protrusion is: S=s·n,

$$\begin{matrix}further , S = \sqrt{2 π {r}^{2} + {p}^{2}} \cdot n , \\ further , S = \sqrt{2 π {r}^{2} + {p}^{2}} \cdot \frac{L}{p} , \\ further , S = \sqrt{\frac{{( 2 π r )}^{2}}{{p}^{2}} + 1} \cdot L .\end{matrix}$$

In conventional research, in order to control the propelling force that the optical cable is subjected to during the air-blowing laying process, additional device is required and multiple tests need to be conducted. Moreover, multiple variables are involved. Each addition or modification of a parameter (such as the height of protruding strip, the width of protruding strip, the shape of protruding strip, the sheath material, etc.) requires re-sampling. It is time-consuming and labor-intensive, and most of the produced samples can only be scrapped in the end.

Now, through the mathematical calculation of quantitative formulas, once specific parameters are fixed according to product requirements, the most suitable production parameters can be directly derived from the formula. Only a few parameters within a reasonable range need to be sampled and tested to obtain the optimal solution, which significantly reduces costs, reduces waste, and improves work efficiency.

For computational convenience, the parameters of the test sample are as follows:
a radius of the outer sheath 3 of optical cable r=0.1 m, a total length of the optical cable L=1 m, a kinetic friction coefficient μ=0.5, a height of the protruding strip h=0.1 mm, the internal pressure of conduit P_{P}=1013250 Pa (10 standard atmospheric pressures).

After calculation, the following table is obtained.

| | Pitch | Height | | | Effect |
|---|---|---|---|---|---|
| No. | p/m | h/mm | S/m | F_{f}/N | evaluation |
| 1 | 0.01 | 0.1 | 89.02 | 72.15 | feasible |
| 2 | 0.05 | 0.1 | 12.60 | 50.91 | feasible |
| 3 | 0.5 | 0.1 | 1.605 | 50.64 | feasible |
| 4 | 1 | 0.1 | 0.628 | 26.94 | Not feasible |

In the present technical solution, when the height of the protruding strip h is set to be 0.1 mm, F_{f} must remain above 50N to successfully achieve a desired air-blowing laying efficiency of the present application. Therefore, in a final set of data in the table, when the pitch P is set to be 1 m and the height of the protruding strip h is set to be 0.1 mm, the propelling force F_{f} is less than 50N, so it fails to achieve the desired effect of the present application and is therefore not feasible.

The greater the setting of the propelling force, the better the effect. However, when the propelling force is too large, the pitch of the spiral protruding strip 5 becomes smaller; but when the pitch of the spiral protruding strip 5 is too small, it cannot be produced. Therefore, to achieve the optimal laying effect of the air-blowing optical cable, the propelling force each meter of the optical cable is greater than 50N, and the pitch of the spiral protruding strip 5 is set to be less than or equal to 0.5 m. Further, when the pitch of the spiral protruding strip 5 is set to be 0.01-0.5 m, on any radial plane of the optical cable, there is only one protrusion, and the air-blowing effect is better.

On any radial plane of the air-blowing optical cable, the shape of the protruding strip 5 is an arc or trapezoid; when the cross-section of the protruding strip 5 is provided to be a trapezoid, the size of the protruding strip 5 increases as it approaches the outer sheath 3, ensuring optimal air-blowing performance. The shape of the protruding strip 5 is typically an arc or trapezoid, and other shapes may also be set, provided that the protruding strip 5 can pass through a sizing die. However, setting as other shape may cause deformation issue. For example, the protruding strip 5 is set to be a triangle, due to its overly sharp tip, after entering the sizing die, it will cause scratching, resulting in indentation. If the protruding strip 5 is set to be a square or rectangle, due to the 90° angle on both sides, it is very prone to scratching, ultimately causing the protruding strip 5 to be worn flat. At the same time, for the air-blowing laying effect of the optical cable when it is laid into the external conduit, when the shape of the protruding strip 5 is set to be an arc or trapezoid, the air-blowing effect is the best.

| | | Whether the | |
|---|---|---|---|
| Shape of | Height of | protruding strip | Whether the air- |
| protruding | protruding | exists after exiting | blowing laying can |
| strip | strip | a sizing die | be completed |
| Arc | 0.1 mm | Yes | Yes |
| Trapezoid | 0.1 mm | Yes | Yes |
| Triangle | 0.1 mm | Yes | No |
| Rectangle | 0.1 mm | Yes | No |

To enhance the strength of the optical cable, reinforcing members 4 are provided within the outer sheath 3. The reinforcing members 4 are provided within the outer sheath 3 circumferentially and uniformly. Due to the circumferential placement mode of the reinforcing member 4, the existing reinforcing member 4 results in poor bending performance of the optical cable; and after the production process of winding and bending the optical cable is completed, it is prone to plastic deformation or flexible deformation, and tends to undergo torsion itself during the air-blowing process. To further ensure the bending performance of the optical cable, in the present solution, the reinforcing member 4 is set as an aramid fiber rod or a glass fiber rod. The size of the reinforcing member 4 is 0.3-0.6 mm, and there are 8-16 reinforcing members, which are evenly distributed around the outer sheath 3.

The outer sheath 3 employs low-friction medium-density polyethylene material, which exhibits excellent low-temperature resistance and stable chemical properties.

In the present solution, the optical cable has a rigidity in a range of 0.45-1.85 N·m², an average conduit friction force in a range of 90-150N and a maximum conduit friction force in a range of 100-200N.

The present application addresses the shortcomings present in the prior art and offers the following beneficial effects: protruding strips 5 are provided on the outer side of the outer sheath 3, reducing friction during the laying of optical cable and external conduits and ensuring the completion of air-blowing optical cable laying; meanwhile, controlling the propelling force F_{f} exerted by the gas to propel the optical cable each meter to be greater than 50N, enables the laying of the optical cable to be completed more quickly and smoothly, saving time and effort. When the propelling force of the optical cable each meter is greater than 50N, the pitch of the spiral protruding strip 5 is set to be less than or equal to 0.5 m to ensure production, guaranteeing the laying efficiency of optical cable.

Enlightened by the ideal embodiments of the present application as set forth above, and through the contents of the above description, relevant personnel can readily make various modifications and changes without departing from the scope of the present application. The technical scope of the present application is not limited to the content of the specification but must be determined based on the scope of the claims.

The embodiments of the present application have been described in detail in combination with the accompanying drawings. However, the present application is not limited to the specific details of the above embodiments. Various simple variations may be made to the technical solutions of the present application within the scope of the technical concept of the present application, and such simple variations are all within the scope of protection of the present application.

Additionally, it should be noted that the various specific technical features described in the above detailed embodiments can be combined in any suitable manner without contradiction. To avoid unnecessary repetition, the present application does not separately describe all possible combinations.

Moreover, various embodiments of the present application may also be combined arbitrarily, provided that such combinations do not contradict the concept of the present application. These combinations shall likewise be considered as part of the disclosed content of the present application.

What is claimed is:

1. An air-blowing optical cable, comprising a cable core and an outer sheath coated on an outside of the cable core, wherein a protruding strip is provided on an outer wall of the outer sheath; a height direction of the protruding strip extends outward along a radial direction of the optical cable; the protruding strip has a length direction extending along an axial direction of the air-blowing optical cable and spirally surrounds an outer surface of the outer sheath, gas advances along a spiral direction of the protruding strip, generating a thrust component on the optical cable in the axial direction; and a propelling force F_{f} that is generated by the thrust component to propel each meter of optical cable to move is greater than 50N, and a calculation formula for the propelling force F_{f} is:
$${F}_{f} = S \cdot μ ( θ ) \cdot {P}_{P} \cdot h ;$$
wherein:
$$S = \sqrt{\frac{{( 2 π r )}^{2}}{{p}^{2}} + 1} \cdot L ; \\ μ ( θ ) = μ \cdot sin θ ; \\ θ = acr tan ( \frac{p}{2 π r} ) ;$$
F_{f} is a radial propelling force exerted on the optical cable during an air-blowing process;
S is a total length of the protruding strip when a starting point of the protruding strip is unfolded along a circumference direction of the optical cable;
μ(θ) is a composite friction coefficient;
r is a radius of the optical cable sheath;
p is a pitch;
L is a total length of the optical cable;
θ is an acute angle between a spiral protruding strip and the axial direction of the optical cable;
P_{P} is an internal pressure within conduit under a given air-blowing device and conduit; and
h is a height of the protruding strip.

2. The air-blowing optical cable according to claim 1, wherein the pitch of the spiral protruding strip is set to be less than or equal to 0.5 m.

3. The air-blowing optical cable according to claim 2, wherein the pitch of the spiral protruding strip is set to be 0.01-0.5 m.

4. The air-blowing optical cable according to claim 1, wherein a cross-section of the protruding strip is an arc or a trapezoid on any radial plane of the air-blowing optical cable; when the cross-section of the protruding strip is set to be a trapezoid, a cross-sectional size of the protruding strip increases as it approaches the outer sheath.

5. The air-blowing optical cable according to claim 1, wherein reinforcing members are provided within the outer sheath, and the reinforcing members are provided within the outer sheath circumferentially and uniformly.

6. The air-blowing optical cable according to claim 5, wherein the reinforcing members are set as an aramid fiber rod or a glass fiber rod.

7. The air-blowing optical cable according to claim 1, wherein the outer sheath is formed of polyethylene material.

8. The air-blowing optical cable according to claim 1, wherein the cable core comprises a plurality of optical fibers and bonding parts that intermittently bonding the plurality of optical fibers in an axial direction, two colored threads are provided outside the plurality of optical fibers, and the two colored threads are wound in opposite directions to bind the plurality of optical fibers into a bundle.

9. The air-blowing optical cable according to claim 8, wherein any bonding part on any optical fiber is a first reference bonding part; an adjacent bonding part on the optical fiber adjacent to the first reference bonding part is a second reference bonding part; an adjacent bonding part on the optical fiber adjacent to the second reference bonding part is a third reference bonding part; wherein the first reference bonding part, the second reference bonding part, and the third reference bonding part are located on a same straight line.

10. The air-blowing optical cable according to claim 8, wherein the air-blowing optical cable has a rigidity of 0.45-1.85 N·m².
